(19) United States
(12) Patent Application Publication
(10) Pub. No.: US 2026/0179213 A1
(43) Pub. Date: Jun. 25, 2026

(54) IMAGE INSPECTION SYSTEM AND IMAGE INSPECTION METHOD

(71) Applicants: Kabushiki Kaisha Toshiba, Tokyo (JP); Toshiba Electronic Devices & Storage Corporation, Tokyo (JP)

(72) Inventor: Ikuo MOTONAGA, Kitakyushu Fukuoka (JP)

(21) Appl. No.: 19/278,626

(22) Filed: Jul. 23, 2025

(30) Foreign Application Priority Data
Dec. 24, 2024 (JP) 2024-227498

(51) Int. Cl. G06T 7/00

(52) U.S. Cl. CPC G06T 7/001

(57) ABSTRACT

According to one embodiment, an image inspection system includes: a lighting condition determination unit configured to determine, based on an inspection target, a lighting condition including a wavelength spectrum and an irradiation angle of light with which the inspection target is irradiated; an optical system configured to irradiate the inspection target with the light having the wavelength spectrum corresponding to the lighting condition at the angle corresponding to the lighting condition; and a determination unit configured to determine whether a shape of the inspection target is good or defective based on imaging data of the inspection target imaged by the light emitted from the optical system.

### CROSS-REFERENCE TO RELATED APPLICATION

This application is based upon and claims the benefit of priority from Japanese Patent Application No. 2024-227498, filed Dec. 24, 2024, the entire contents of which are incorporated herein by reference.

### FIELD

Embodiments described herein relate generally to an image inspection system and an image inspection method.

### BACKGROUND

An image inspection system that inspects whether an appearance of a semiconductor product in the middle of being assembled has a prescribed shape in a manufacturing process of the semiconductor product is known.

### BRIEF DESCRIPTION OF DRAWINGS

FIG. 1 is a view illustrating an example of a configuration of a semiconductor device assembly facility including an image inspection system according to an embodiment.

FIG. 2 is a view illustrating an example of a configuration of a lead frame carried into the image inspection system according to the embodiment.

FIG. 3 is a view illustrating an example of a configuration of an element portion of the lead frame carried into the image inspection system according to the embodiment.

FIG. 4 is a view illustrating an example of a configuration of the image inspection system according to the embodiment.

FIG. 5 is a view illustrating an example of arrangement of oblique lightings in the image inspection system according to the embodiment.

FIG. 6 is a block diagram illustrating an example of a hardware configuration of a lighting condition control apparatus included in the image inspection system according to the embodiment.

FIG. 7 is a block diagram illustrating an example of a functional configuration of the lighting condition control apparatus included in the image inspection system according to the embodiment.

FIG. 8 is a diagram illustrating an example of a data structure of inspection target information according to the embodiment.

FIG. 9 is a diagram illustrating an example of a data structure of a lighting condition DB according to the embodiment.

FIG. 10 is a block diagram illustrating an example of a hardware configuration of a shape determination apparatus included in the image inspection system according to the embodiment.

FIG. 11 is a block diagram illustrating an example of a functional configuration of the shape determination apparatus included in the image inspection system according to the embodiment.

FIG. 12 is a diagram illustrating a first example of imaging data acquired by the image inspection system according to the embodiment.

FIG. 13 is a diagram illustrating a second example of imaging data acquired by the image inspection system according to the embodiment.

FIG. 14 is a flowchart illustrating an example of lighting condition control processing in the image inspection system according to the embodiment.

FIG. 15 is a flowchart illustrating an example of shape determination processing in the image inspection system according to the embodiment.

### DETAILED DESCRIPTION

In general, according to one embodiment, an image inspection system includes: a lighting condition determination unit configured to determine, based on an inspection target, a lighting condition including a wavelength spectrum and an irradiation angle of light with which the inspection target is irradiated; an optical system configured to irradiate the inspection target with the light having the wavelength spectrum corresponding to the lighting condition at the angle corresponding to the lighting condition; and a determination unit configured to determine whether a shape of the inspection target is good or defective based on imaging data of the inspection target imaged by the light emitted from the optical system.

Hereinafter, embodiments will be described with reference to the drawings. Note that, in the following description, components having the same function and configuration are denoted by the same reference numerals.

### 1. Configuration

### 1.1 Semiconductor Device Assembly Facility

FIG. 1 is a view illustrating an example of a configuration of a semiconductor device assembly facility including an image inspection system according to an embodiment.

The semiconductor device assembly facility 1 is a facility for automatically assembling a semiconductor device. As illustrated in FIG. 1, a semiconductor device assembly facility 1 includes an image inspection system 2 and a conveyance path 3. More specifically, for example, the semiconductor device assembly facility 1 is a facility in which a die attachment paste material 5 is applied onto a bed portion BD of the lead frame 4, shape measurement is performed by the image inspection system 2, and individualized semiconductor chips that have been determined to be good are mounted. Note that a step of connecting a pad portion of the semiconductor chip and a lead portion LD of the lead frame 4 with a wire, a step of sealing the semiconductor chip, and a step of separating the sealed semiconductor chip from the lead frame 4 are executed on the bed portion BD of the lead frame 4 on which the semiconductor chip is mounted after being carried out from the semiconductor device assembly facility 1.

The image inspection system 2 is a system configured to inspect the shape of the die attachment paste material 5 for bonding the lead frame 4 and the semiconductor chip in processing, described above, of placing the semiconductor chip on the lead frame 4. In the image inspection system 2, for example, the lead frame 4 with the die attachment paste material 5 provided on an upper surface and before the semiconductor chip is placed is carried in along the conveyance path 3 as an inspection target TG. The image inspection system 2 determines whether or not a die attachment paste material 5 having a prescribed shape (area, size, and the like) is provided on the lead frame 4. In a case where the die attachment paste material 5 has a prescribed shape, the image inspection system 2 determines that the die attachment paste material 5 passes the inspection. In a case where the die attachment paste material 5 does not have the prescribed shape, the image inspection system 2 determines that the die attachment paste material 5 has failed the inspection. The die attachment paste material 5 that has passed the inspection is used for adhesion between the lead frame 4 and the semiconductor chip in the subsequent processing. On the other hand, the die attachment paste material 5 failed in the inspection is not used for adhesion between the lead frame 4 and the semiconductor chip in the subsequent processing.

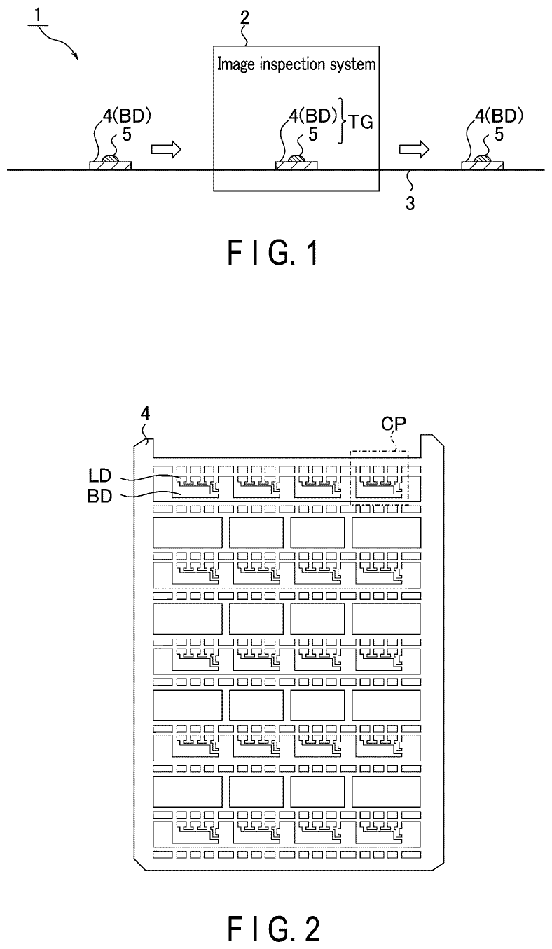

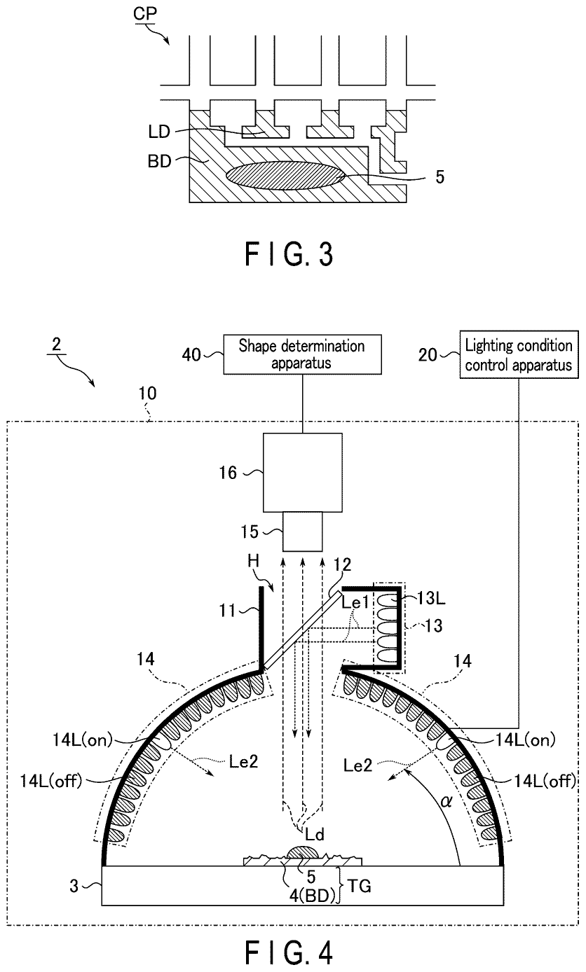

FIG. 2 is a view illustrating an example of a configuration of a lead frame carried into the image inspection system according to the embodiment. FIG. 3 is a view illustrating an example of a configuration of an element portion of the lead frame carried into the image inspection system according to the embodiment. FIG. 3 corresponds to an enlarged view of one element portion CP in FIG. 2.

As illustrated in FIG. 2, the lead frame 4 is, for example, a metal member in which a plurality of element portions CP each corresponding to one semiconductor chip are connected in a strip shape of m rows and n columns. FIG. 2 illustrates an example in which 20 element portions CP of 5 rows×4 columns form one lead frame 4.

The element portion CP includes the bed portion BD and the lead portion LD. The bed portion BD is a region electrically connected to the semiconductor chip via the die attachment paste material 5. The lead portion LD is a region that is electrically connected to the semiconductor chip via bonding wires. A part of the bed portion BD and a part of the lead portion LD are covered with a sealing resin that seals a semiconductor chip by subsequent processing. The bed portion BD and a part of the lead portion LD (hatched region in FIG. 3) may be subjected to roughening plating on a surface in order to improve adhesion between a surface of the lead frame 4 and the sealing resin. The roughening plating is, for example, a treatment for significantly roughening the surface roughness when the surface of the lead portion LD is coated with a metal. The lead portion LD subjected to the roughening plating has a property of irregularly reflecting incident light. The surface of the lead portion LD subjected to the roughening plating contains, for example, at least one metal selected from nickel, palladium, gold, and silver. Note that reflectance, absorptivity, and transmittance of the lead portion LD subjected to the roughening plating may change according to the surface roughness of the lead portion LD and the ratio of the metal contained in the lead portion LD (that is, the shape and the material). The shape and material of the lead portion LD subjected to the roughening plating may be changed depending on the type of the lead frame 4, the method of the roughening plating, and the like.

The die attachment paste material 5 is an adhesive for fixing the semiconductor chip on the bed portion BD of the lead frame 4. The die attachment paste material 5 contains, for example, an epoxy-based silver paste. The die attachment paste material 5 has a shape in which the surface has a constant curvature. As described above, since the die attachment paste material 5 contains silver as a main component, the die attachment paste material 5 has a relatively high reflectance, but has a property of irregularly reflecting light. The reflectance, the absorptivity, and the transmittance of the die attachment paste material 5 may be changed according to the shape and the material of the die attachment paste material 5. The shape and material of the die attachment paste material 5 may vary depending on the type of the die attachment paste material 5 and the like.

Note that, as described above, one lead frame 4 is provided with a plurality of die attachment paste materials 5 corresponding to the respective bed portions BD for a plurality of elements. In FIG. 1 and subsequent FIG. 4, for convenience of description, the bed portion BD for one element and one of a plurality of die attachment paste materials 5 provided on the bed portion BD are illustrated.

### 1.2 Image Inspection System

FIG. 4 is a view illustrating an example of a configuration of the image inspection system according to the embodiment. FIG. 4 is a cross-sectional view of the image inspection system 2 taken along a plane perpendicular to the conveyance path 3.

As illustrated in FIG. 4, the image inspection system 2 includes an optical system 10, a lighting condition control apparatus 20, and a shape determination apparatus 40. The optical system 10 includes a housing 11, a half mirror 12, a coaxial lighting 13, an oblique lighting 14, a lens 15, and an imaging element 16.

The housing 11 is disposed between the conveyance path 3 and a set of the lens 15 and the imaging element 16. The housing 11 covers the lead frame 4 and the die attachment paste material 5, which are the inspection target TG, and the upper portion of the conveyance path 3. The housing 11 incorporates the half mirror 12, the coaxial lighting 13, and the oblique lighting 14 used for imaging the inspection target TG.

A portion of the housing 11 in which the half mirror 12 and the coaxial lighting 13 are incorporated has, for example, a box shape. The portion of the housing 11 in which the half mirror 12 and the coaxial lighting 13 are incorporated is arranged closer to a side of a set of the lens 15 and the imaging element 16 than a portion in which the oblique lighting 14 is incorporated. An opening H is provided in a surface facing the lens 15 in a portion of the housing 11 in which the half mirror 12 and the coaxial lighting 13 are incorporated.

The half mirror 12 is disposed so as to be inclined at a predetermined angle (for example, 45°) with respect to a surface (that is, a surface parallel to the opening H) facing the lens 15. The half mirror 12 reflects light in a direction substantially horizontal to the surface facing the lens 15 among light emitted in the housing 11 to the inside of the housing 11. The half mirror 12 transmits light in a direction vertically incident on the lens 15 among the light emitted in the housing 11 to the outside of the housing 11.

The coaxial lighting 13 is a light source arranged so as to be aligned with the half mirror 12 in a direction substantially horizontal to the surface facing the lens 15. That is, light Le1 emitted from the coaxial lighting 13 is reflected by the half mirror 12 in a direction (coaxial direction) substantially perpendicular to the surface facing the lens 15, and is emitted to the inspection target TG.

The coaxial lighting 13 includes a plurality of lamp elements 13L. Each of the plurality of lamp elements 13L includes, for example, a white light source, a red light source, a green light source, and a blue light source. The red light source, the green light source, and the blue light source are red, green, and blue LED elements, respectively. The white light source is a combination of an ultraviolet LED element and a phosphor. These four LED elements and phosphors are incorporated in one lamp element 13L. Each of the plurality of lamp elements 13L is configured to be able to freely adjust the color (wavelength spectrum) of the light Le1 emitted from the coaxial lighting 13 at least in a visible light region by independently controlling outputs of the four LED elements. The visible light region includes, for example, a range of 400 nm or more and 800 nm or less. Note that the wavelength spectrum in the visible light region can be implemented by three elements of a red light source, a green light source, and a blue light source, but from the viewpoint of increasing the output, a white light source evenly including the entire wavelength region is incorporated in each of the plurality of lamp elements 13L.

A portion of the housing 11 incorporating the plurality of oblique lightings 14 has, for example, a dome shape, and is connected to a portion incorporating the half mirror 12 and the coaxial lighting 13 at a zenith portion thereof.

The oblique lighting 14 is a light source disposed in a dome-shaped portion of the housing 11. The oblique lighting 14 includes a plurality of lamp elements 14L. The lamp elements 14L are comprehensively arranged in a dome-shaped portion of the housing 11. In FIG. 4, among the plurality of lamp elements 14L, a portion arranged in a semicircular arc shape in a certain cross section of the housing 11 is illustrated, but arrangement positions of the plurality of lamp elements 14L are not limited thereto.

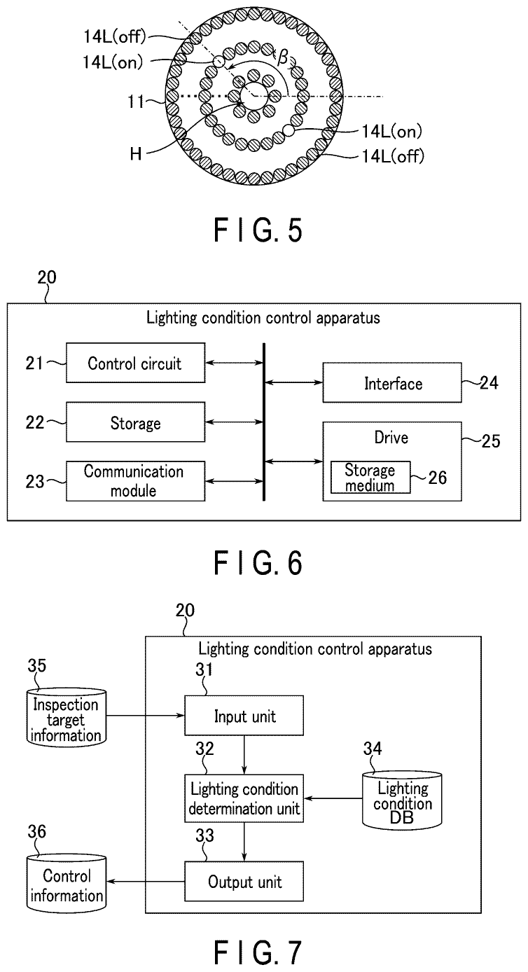

FIG. 5 is a view illustrating an example of arrangement of oblique lightings in the image inspection system according to the embodiment. FIG. 5 is a plan view illustrating arrangement of the plurality of lamp elements 14L when the image inspection system 2 is viewed from the imaging element 16 side to the conveyance path 3 side.

The plurality of lamp elements 14L is circumferentially arranged at the same level (height from the conveyance path 3) on the inner surface of the dome-shaped housing 11. The plurality of lamp elements 14L is configured to independently switch between an on state and an off state.

In the examples of FIGS. 4 and 5, a case where two lamp elements 14L located diagonally among the plurality of lamp elements 14L arranged circumferentially at a position of a certain height from the conveyance path 3 side are selectively turned on is illustrated. In this manner, the inspection target TG is irradiated with light Le2 emitted from the oblique lighting 14 at any angle above the conveyance path 3. Here, the angle means a set of the elevation angle α and the azimuth angle β centered on the inspection target TG.

Each of the plurality of lamp elements 14L includes, for example, a white light source, a red light source, a green light source, and a blue light source. The red light source, the green light source, and the blue light source are red, green, and blue LED elements, respectively. The white light source is a combination of an ultraviolet LED element and a phosphor. These four LED elements and phosphors are incorporated in one lamp element 14L. Each of the plurality of lamp elements 14L is configured to be able to arbitrarily adjust the color (wavelength spectrum) of the light Le2 emitted from each of the plurality of lamp elements 14L at least in the visible light region by independently controlling the outputs of the four LED elements. Note that the wavelength spectrum in the visible light region can be implemented by three elements of a red light source, a green light source, and a blue light source, but from the viewpoint of increasing the output, a white light source evenly including the entire wavelength region is incorporated in each of the plurality of lamp elements 14L.

Of the light Le1 and the light Le2 applied to the inspection target TG, the light Ld reflected in the coaxial direction passes through the half mirror 12 and enters the lens 15. The lens 15 condenses the incident light Ld and guides the light to the imaging element 16.

The imaging element 16 is, for example, a charge coupled device (CCD) image sensor. The imaging element 16 images the inspection target TG based on the light Ld from the housing 11. The imaging element 16 inputs data (imaging data) obtained by imaging to the shape determination apparatus 40.

The lighting condition control apparatus 20 is, for example, an information processing apparatus such as a personal computer (PC). The lighting condition control apparatus 20 controls the on state and the off state of each of the coaxial lighting 13 and the oblique lighting 14 independently of each other. In addition, the lighting condition control apparatus 20 controls the on state and the off state of each of the plurality of lamp elements 14L constituting the oblique lighting 14 independently of each other. The lighting condition control apparatus 20 controls the intensities of the white light source, the red light source, the green light source, and the blue light source included in each of the lamp elements 13L and 14L to be turned on independently of each other. Thus, the lighting condition control apparatus 20 can adjust the lighting conditions of the light with which the inspection target TG is irradiated. Here, the lighting conditions include an irradiation angle (position) and a wavelength spectrum of irradiation light.

The shape determination apparatus 40 is, for example, an information processing apparatus such as a PC. The shape determination apparatus 40 detects the die attachment paste material 5 provided on the lead frame 4 based on the imaging data input from the imaging element 16. The shape determination apparatus 40 determines whether or not the detected die attachment paste material 5 has a prescribed shape.

With the above configuration, the image inspection system 2 can determine good or bad of the die attachment paste material 5 from the viewpoint of mounting the semiconductor chip on the lead frame 4.

### 1.3 Lighting Condition Control Apparatus

FIG. 6 is a block diagram illustrating an example of a hardware configuration of the lighting condition control apparatus included in the image inspection system according to the embodiment.

As illustrated in FIG. 6, the lighting condition control apparatus 20 includes, for example, a control circuit 21, a storage 22, a communication module 23, an interface 24, a drive 25, and a storage medium 26.

The control circuit 21 is a circuit that entirely controls each component of the lighting condition control apparatus 20. The control circuit 21 includes a central processing unit (CPU), a random access memory (RAM), a read only memory (ROM), and the like. The CPU of the control circuit 21 controls the entire lighting condition control apparatus 20 according to a program stored in the ROM of the control circuit 21. The RAM of the control circuit 21 has a work area of the CPU of the control circuit 21. The ROM of the control circuit 21 stores programs and the like used by the lighting condition control apparatus 20.

The storage 22 includes, for example, a hard disk drive (HDD) or a solid state drive (SSD). The storage 22 stores information used in lighting condition control processing of the coaxial lighting 13 and the plurality of oblique lightings 14 by the lighting condition control apparatus 20.

The communication module 23 is a circuit used for transmission and reception of data between the lighting condition control apparatus 20 and the outside. The communication module 23 may be configured to connect the lighting condition control apparatus 20 and a network (not illustrated).

The interface 24 is an interface that manages communication with a user. The interface 24 includes an input device and an output device. The input device includes, for example, a keyboard, a touch panel, an operation button, and the like. The output device includes, for example, a liquid crystal display (LCD) or an electroluminescence (EL) display, a printer, and the like. The output device may, for example, display the lighting conditions on a display.

The drive 25 is a device for reading software stored in the storage medium 26. The drive 25 includes, for example, a compact disk (CD) drive or a digital versatile disk (DVD) drive.

The storage medium 26 is a medium that stores software. The storage medium 26 may store a program used by the lighting condition control apparatus 20.

FIG. 7 is a block diagram illustrating an example of a functional configuration of the lighting condition control apparatus included in the image inspection system according to the embodiment.

As illustrated in FIG. 7, the control circuit 21 of the lighting condition control apparatus 20 functions as a computer including an input unit 31, a lighting condition determination unit 32, and an output unit 33. In addition, the storage 22 of the lighting condition control apparatus 20 stores a lighting condition DB 34.

The input unit 31 receives an input of inspection target information 35. The input unit 31 sends an ID included in the input inspection target information 35 to the lighting condition determination unit 32 as information for determining lighting conditions to be applied to the inspection target TG.

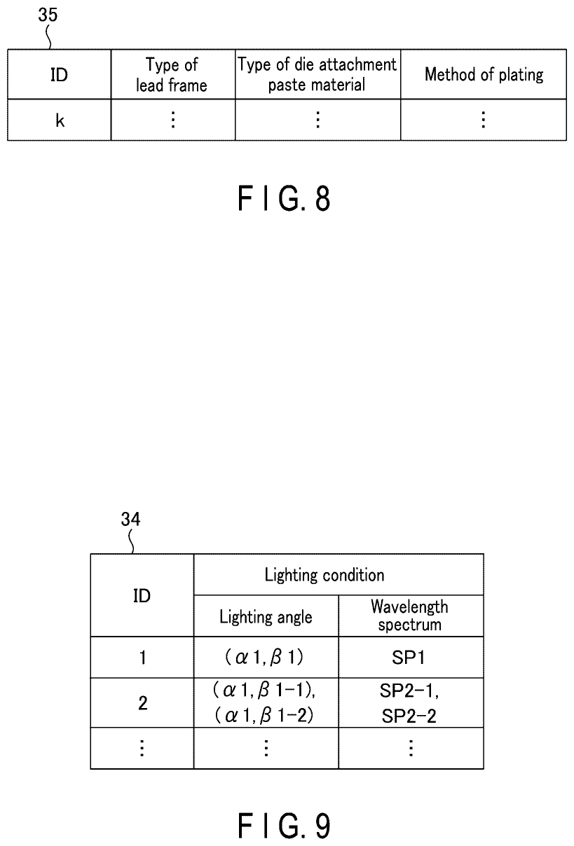

The inspection target information 35 is information used to determine the lighting conditions of light with which the inspection target TG carried into the image inspection system 2 is irradiated. FIG. 8 is a diagram illustrating an example of a data structure of the inspection target information according to the embodiment. As illustrated in FIG. 8, the inspection target information 35 is information in which information such as an ID, a lead frame type, a die attachment paste material type, and a method of plating is associated with each other.

The ID is an identifier for identifying the inspection target TG in association with lighting conditions. That is, a common ID is assigned to inspection targets TG to which common lighting conditions are applied. On the other hand, different IDs are assigned to inspection targets TG to which different lighting conditions are applied.

The lead frame type and the die attachment paste material type each include, for example, information of the material of the lead frame and the material of the die attachment paste material.

The method of plating includes information of a method of plating to be applied to the lead frame. Types of plating include, for example, planarization plating and roughening plating. In addition, the type of the roughening plating may include a plurality of types such as a method of providing roughened plating and a method of performing roughening by performing chemical liquid treatment after providing the flattened plating.

Upon receiving the ID included in the inspection target information 35, the lighting condition determination unit 32 refers to the lighting condition DB 34 and determines the lighting conditions corresponding to the ID. The lighting condition determination unit 32 generates control information 36 of the coaxial lighting 13 and the plurality of oblique lightings 14 based on the determined lighting conditions. The lighting condition determination unit 32 sends the generated control information 36 to the output unit 33.

The lighting condition DB 34 is a database that stores lighting conditions for detecting the die attachment paste material 5 on the lead frame 4 in the shape determination apparatus 40. In the lighting condition DB 34, lighting conditions that have been previously confirmed to be capable of detecting the die attachment paste material 5 by an experiment or the like are associated with each ID and stored in a database. FIG. 9 is a diagram illustrating an example of a data structure of the lighting condition DB according to the embodiment. As illustrated in FIG. 9, the lighting condition DB 34 stores a plurality of entries each including a set of an ID and lighting conditions. Specifically, the lighting conditions include information of a wavelength spectrum and an irradiation angle.

The information of the irradiation angle designates (elevation angle, azimuth angle)=(α, β) of the lamp element 14L to be turned on. The number of designated irradiation angles may be one or plural.

The information of the wavelength spectrum specifies, for example, a spectrum of light intensity in a visible light region. That is, the information of the wavelength spectrum is an intensity distribution for each wavelength in the visible light region of light (light from the combination of the white light source, the red light source, the green light source, and the blue light source) emitted from the lamp element 14L to be turned on. The number of wavelength spectra designated in association with one ID may be one type or a plurality of types. The number of wavelength spectra designated in association with one ID may be designated according to the number of irradiation angles designated in association with the ID.

The lighting condition determination unit 32 determines the lamp element 14L to be turned on based on the information of the irradiation angle. Then, the lighting condition determination unit 32 determines the intensity of each of the white light source, the red light source, the green light source, and the blue light source in the lamp element 14L to be turned on based on the information of the wavelength spectrum. The lighting condition determination unit 32 generates the control information 36 including the determined various types of information and transmits the control information to the output unit 33. Note that, in the above example, the case where the intensity distribution of the light by the combination of various light sources emitted from the lamp element 14L is stored in the lighting condition DB 34 as the information of the wavelength spectrum has been described, but the embodiment is not limited thereto. For example, in the lighting condition DB 34, a set of information indicating the intensity of each of various light sources emitted from the lamp element 14L may be stored as the information of the wavelength spectrum. In this case, the lighting condition determination unit 32 can include the information of the wavelength spectrum in the lighting condition DB 34 in the control information 36 as it is.

The output unit 33 outputs the control information 36 generated by the lighting condition determination unit 32 to the coaxial lighting 13 and the plurality of oblique lightings 14. Thus, the output unit 33 can selectively turn on the lighting arranged at the position corresponding to the determined lighting condition among the coaxial lighting 13 and the plurality of oblique lightings 14. Then, the output unit 33 can emit light having a wavelength spectrum corresponding to the determined lighting conditions from the lighting turned on.

### 1.4 Shape Determination Apparatus

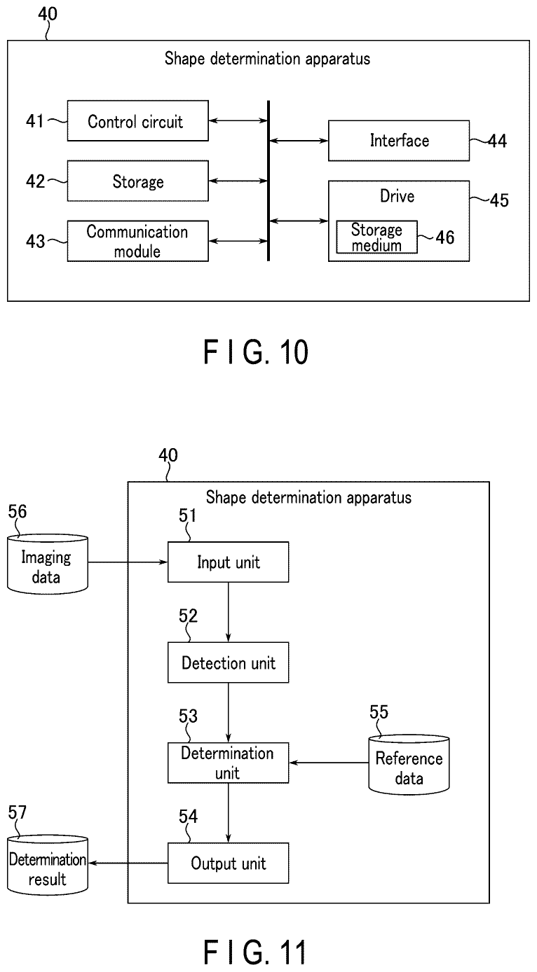

FIG. 10 is a block diagram illustrating an example of a hardware configuration of the shape determination apparatus included in the image inspection system according to the embodiment.

As illustrated in FIG. 10, the shape determination apparatus 40 includes, for example, a control circuit 41, a storage 42, a communication module 43, an interface 44, a drive 45, and a storage medium 46.

The control circuit 41 is a circuit that entirely controls each component of the shape determination apparatus 40. The control circuit 41 includes a CPU, a RAM, a ROM, and the like. The CPU of the control circuit 41 controls the entire shape determination apparatus 40 according to a program stored in the ROM of the control circuit 41. The RAM of the control circuit 41 has a work area of the CPU of the control circuit 41. The ROM of the control circuit 41 stores programs and the like used by the shape determination apparatus 40.

The storage 42 includes, for example, an HDD or an SSD. The storage 42 stores information used in the shape determination processing of the die attachment paste material 5 by the shape determination apparatus 40.

The communication module 43 is a circuit used for transmission and reception of data between the shape determination apparatus 40 and the outside. The communication module 43 may be configured to connect the shape determination apparatus 40 and a network (not illustrated).

The interface 44 is an interface that manages communication with a user. The interface 44 includes an input device and an output device. The input device includes, for example, a keyboard, a touch panel, an operation button, and the like. The output device includes, for example, an LCD or an EL display, a printer, and the like. The output device can display the result of the shape determination processing on the display, for example.

The drive 45 is a device for reading software stored in the storage medium 46. The drive 45 includes, for example, a CD drive or a DVD drive.

The storage medium 46 is a medium that stores software. The storage medium 46 may store a program used by the shape determination apparatus 40.

FIG. 11 is a block diagram illustrating an example of a functional configuration of the shape determination apparatus included in the image inspection system according to the embodiment.

As illustrated in FIG. 11, the control circuit 41 of the shape determination apparatus 40 functions as a computer including an input unit 51, a detection unit 52, a determination unit 53, and an output unit 54. Further, the storage 42 of the shape determination apparatus 40 stores reference data 55.

The input unit 51 receives an input of imaging data 56 generated by the imaging element 16. The input unit 51 sends the input imaging data 56 to the detection unit 52.

The detection unit 52 detects a portion provided with the die attachment paste material 5 from the lead frame 4 illustrated in the imaging data 56. For example, the detection unit 52 detects a boundary between the lead frame 4 and the die attachment paste material 5 based on contrast (that is, a luminance difference between the lead frame 4 and the die attachment paste material 5) in the imaging data 56. The detection unit 52 sends information regarding the detected boundary between the lead frame 4 and the die attachment paste material 5 to the determination unit 53.

Note that, from the viewpoint of highly accurate detection, the contrast between the lead frame 4 and the die attachment paste material 5 is preferably large.

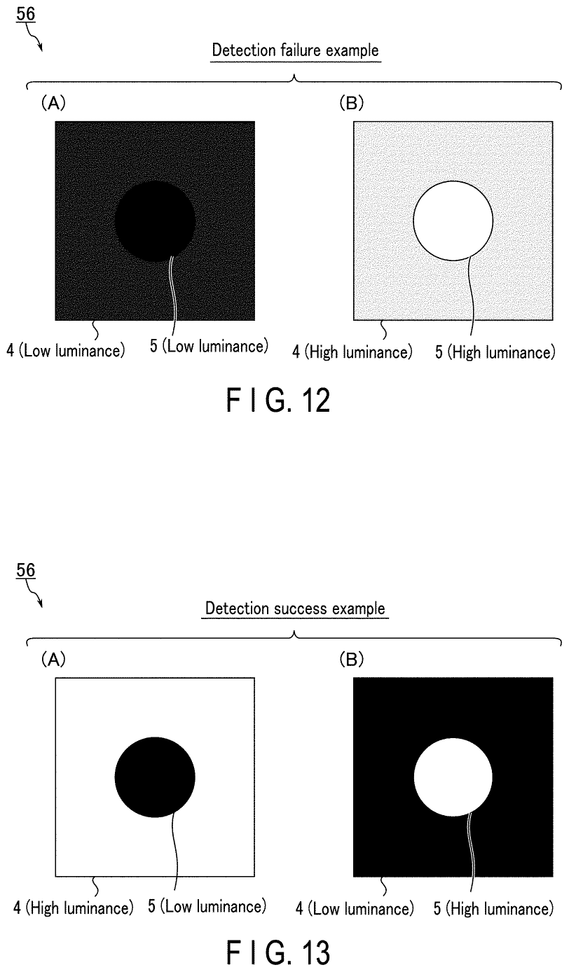

FIG. 12 is a diagram illustrating a first example of imaging data acquired by the image inspection system according to the embodiment. FIG. 13 is a diagram illustrating a second example of imaging data acquired by the image inspection system according to the embodiment. FIGS. 12 and 13 correspond to a case where the detection unit 52 successfully detects the boundary between the lead frame 4 and the die attachment paste material 5 and a case where the detection unit fails to detect the boundary.

As described above, since the lead frame 4 and the die attachment paste material 5 have different materials and shapes, characteristics such as reflectance, absorptivity, and transmittance, and the degree of irregular reflection are different from each other. Thus, the luminance of the portion corresponding to each of the lead frame 4 and the die attachment paste material 5 in the imaging data 56 changes independently of each other with respect to the change in the lighting conditions. Accordingly, as illustrated in FIG. 12, in a case where the lighting conditions are inappropriate, both the luminance of the portion corresponding to the lead frame 4 and the luminance of the portion corresponding to the die attachment paste material 5 decrease or increase, and detection tends to fail. On the other hand, as illustrated in FIG. 13, if the lighting conditions can be appropriately set, either the luminance of the portion corresponding to the lead frame 4 or the luminance of the portion corresponding to the die attachment paste material 5 can be made high and the other can be made low, and the detection can be made easily successful.

The determination unit 53 determines whether or not the die attachment paste material 5 is provided in a prescribed shape based on information regarding a boundary between the lead frame 4 and the die attachment paste material 5. In the determination, for example, the determination unit 53 uses the reference data 55 as a comparison target. The reference data 55 is information indicating a prescribed shape of the die attachment paste material 5. For example, the determination unit 53 compares the reference data 55 with a detection result by the detection unit 52, and determines whether or not a shape difference therebetween is less than a threshold value. As the threshold, for example, an index such as a radius and an area of die attachment paste material 5 can be used. In a case where the shape difference is less than the threshold value, the determination unit 53 determines that the lead frame 4 and the die attachment paste material 5 of the inspection target TG are good (determination is OK). In a case where the shape difference is equal to or larger than the threshold value, the determination unit 53 determines that the lead frame 4 and the die attachment paste material 5 of the inspection target TG are defective (determination is NG). The determination unit 53 sends a determination result 57 to the output unit 54.

The output unit 54 outputs the determination result 57 by the determination unit 53 to the outside. Thus, in a case where the determination is OK, the semiconductor device assembly facility 1 can grasp that a subsequent processing step is performed on the inspection target TG. Further, in a case where the determination is NG, the semiconductor device assembly facility 1 can grasp that the subsequent processing step is not performed on the inspection target TG.

### 2. Operation

Next, an operation in the image inspection system 2 will be described.

### 2.1 Lighting Condition Control Processing

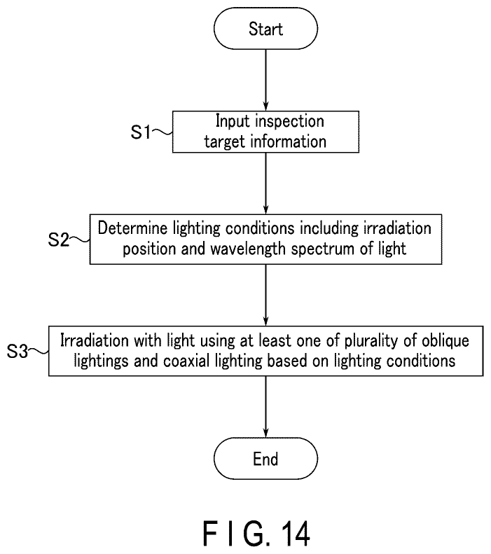

FIG. 14 is a flowchart illustrating an example of the lighting condition control processing in the image inspection system according to the embodiment. FIG. 14 illustrates a flowchart corresponding to the lighting condition control processing for one inspection target TG.

When the inspection target TG is carried in the housing 11 (start), the input unit 31 of the lighting condition control apparatus 20 acquires the inspection target information 35 for determining the lighting conditions of the inspection target TG (S1). As a method of acquiring the inspection target information 35, there may be a method of acquiring the inspection target information 35 manually input by the worker via the interface 24. In addition, the input unit 31 may acquire the inspection target information 35 included in code information by reading the code information printed or engraved in the inspection target TG. The inspection target information 35 includes, for example, information for specifying the material and shape of each of the lead frame 4 and the die attachment paste material 5. More specifically, for example, the inspection target information 35 includes information such as a product name and a lot number of the semiconductor device assembled by the inspection target TG, material names of the lead frame 4 and the die attachment paste material 5, and a method of the roughening plating applied to the lead frame 4.

The lighting condition determination unit 32 of the lighting condition control apparatus 20 determines the lighting conditions including the irradiation angle and the wavelength spectrum of the light based on the inspection target information 35 acquired in the processing of S1 (S2). More specifically, the lighting condition determination unit 32 refers to the lighting condition DB 34 and determines the lighting conditions including the irradiation angle and the wavelength spectrum that can increase the contrast of the portion corresponding to the lead frame 4 and the die attachment paste material 5 in the imaging data 56 among the coaxial lighting 13 and the plurality of oblique lightings 14. The lighting condition determination unit 32 generates the control information 36 corresponding to the determined lighting condition.

The output unit 33 of the lighting condition control apparatus 20 irradiates the inspection target TG with light using at least one of the coaxial lighting 13 and the plurality of oblique lightings 14 based on the lighting conditions determined in the processing of S2 (S3). Specifically, the output unit 33 controls the coaxial lighting 13 and the plurality of oblique lightings 14 using the control information 36 corresponding to the lighting conditions. Thus, the output unit 33 selectively turns on the lighting provided at the angle corresponding to the lighting condition among the coaxial lighting 13 and the plurality of oblique lightings 14. Then, the output unit 33 causes the lighting in the on state to emit light having a wavelength spectrum corresponding to the lighting conditions.

When the processing of S3 ends, the lighting condition control processing ends (end).

### 2.2 Shape Determination Processing

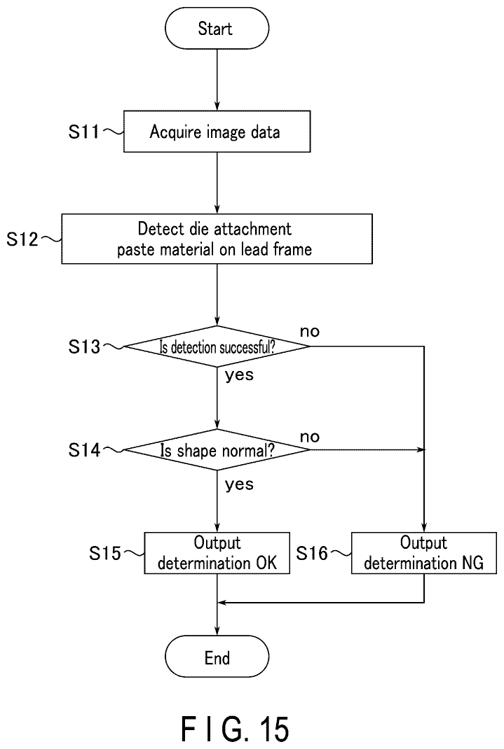

FIG. 15 is a flowchart illustrating an example of shape determination processing in the image inspection system according to the embodiment. FIG. 15 illustrates a flowchart corresponding to shape determination processing for one inspection target TG.

When the inspection target TG is irradiated with light corresponding to the lighting condition (start), the input unit 51 of the shape determination apparatus 40 acquires the imaging data 56 from the imaging element 16 (S11).

The detection unit 52 of the shape determination apparatus 40 detects a portion where the die attachment paste material 5 is provided from the lead frame 4 appearing in the imaging data 56 acquired in the processing of S11 (S12).

The detection unit 52 of the shape determination apparatus 40 determines whether or not the detection of the die attachment paste material 5 by the processing of S12 is successful (S13).

In a case where the detection of the die attachment paste material 5 is successful (S13; yes), the determination unit 53 of the shape determination apparatus 40 determines whether or not the shape of the die attachment paste material 5 detected in the processing of S13 is normal (S14).

In a case where the shape of the die attachment paste material 5 is normal (S14; yes), the output unit 54 of the shape determination apparatus 40 outputs information indicating determination OK (S15).

In a case where the detection of the die attachment paste material 5 fails (S13; no), or in a case where the shape of the die attachment paste material 5 is not normal (S14; no), the output unit 54 outputs information indicating determination NG (S16).

After the processing of S15 or the processing of S16, the shape determination processing ends (end). Note that a semiconductor chip is mounted on the bed portion BD provided with the die attachment paste material 5 determined to be OK in the processing of S15. The semiconductor chip is not mounted on the bed portion BD provided with the die attachment paste material 5 determined as NG in the processing of S15.

### 3. Effects According to Embodiment

According to the embodiment, the lighting condition determination unit 32 determines the lighting conditions including the wavelength spectrum and the irradiation angle of the light with which the inspection target TG is irradiated according to the inspection target TG. The optical system 10 is configured to irradiate the inspection target TG with light having a wavelength spectrum corresponding to the lighting condition at an angle corresponding to the lighting condition. Thus, the determination unit 53 can determine whether the shape of the inspection target TG is good or defective based on the imaging data 56 captured under the lighting conditions optimized so that the luminance difference between the lead frame 4 and the die attachment paste material 5 increases for each inspection target TG. Accordingly, the detection accuracy of the die attachment paste material 5 can be improved.

As a supplement, for the coaxial lighting, the lead frame plated so that the upper surface is flat is specularly reflected, but the die attachment paste material is diffusely reflected. Thus, in the imaging data obtained by using the coaxial lighting, the lead frame that is not subjected to the roughening plating and the die attachment paste material provided on the lead frame can be easily made largely different in luminance. However, the lead frame whose upper surface is subjected to the roughening plating is irregularly reflected due to the uneven shape. For this reason, in the imaging data obtained by using the coaxial lighting, both the lead frame subjected to the roughening plating and the die attachment paste material provided on the lead frame have low luminance, and there is a possibility that the detection accuracy is lowered. In addition, the degree of diffuse reflection and the reflectance vary depending on the shape and the material. Therefore, even in the lead frame subjected to the roughening plating, the optimum lighting conditions may vary depending on the type of the lead frame and the method of the roughening plating.

According to the present embodiment, the lighting condition determination unit 32 is configured to determine different lighting conditions for two inspection targets TG in which at least one selected from the type of the lead frame 4, the type of the die attachment paste material 5, and the method of the roughening plating is different from each other. Thus, in a case where the lead frame is not subjected to the roughening plating, the lighting condition determination unit 32 can determine the lighting conditions that cause the optical system 10 to function as the coaxial lighting. In a case where the lead frame is subjected to the roughening plating, the lighting condition determination unit 32 can determine the lighting conditions that cause the optical system 10 to function as the oblique lighting. Furthermore, even in a case where the lead frame is subjected to the roughening plating, the lighting condition determination unit 32 can select the optimum lighting conditions based on the inspection target information 35.

### 4. Modification and the like

Various modifications can be applied to the above-described embodiments.

In the above-described embodiment, the case where the coaxial lighting 13 and the plurality of oblique lightings 14 are comprehensively arranged in the housing 11 has been described, but the embodiment is not limited thereto. For example, one or more lightings may be intermittently disposed in the housing 11. In this case, one or a plurality of lightings arranged in the housing 11 may be configured to be movable to any position according to lighting conditions. Thus, similarly to the above-described embodiment, it is possible to implement irradiation at an optimum irradiation angle and wavelength spectrum for each inspection target TG.

Further, in the above-described embodiment, in a case where the detection of the die attachment paste material 5 fails in the detection processing of S13 (S13; no), the case of outputting the determination NG has been described, but the embodiment is not limited thereto. For example, in a case where the detection of the die attachment paste material 5 fails in the processing of S13 (S13; no), the image inspection system 2 may change the lighting conditions, acquire the imaging data again, and perform the detection processing again. Here, new lighting conditions to be applied may be lighting conditions stored in the lighting condition DB 34 or lighting conditions obtained by finely adjusting the lighting conditions for which the detection processing has failed.

Further, in the above-described embodiment, the case where the lighting condition control apparatus 20 and the shape determination apparatus 40 are individual devices has been described, but the embodiment is not limited thereto. For example, the lighting condition control apparatus 20 and the shape determination apparatus 40 may be mounted as one apparatus or may be formed integrally with the housing 11.

In the embodiment described above, the case where the programs for executing the lighting condition control processing and the shape determination processing are executed by the lighting condition control apparatus 20 and the shape determination apparatus 40, respectively, has been described, but the embodiment is not limited thereto. For example, the programs for executing the lighting condition control processing and the shape determination processing may be executed by a calculation resource on a cloud configured in a network (not illustrated).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image inspection system comprising:
a lighting condition determination unit configured to determine, based on an inspection target, a lighting condition including a wavelength spectrum and an irradiation angle of light with which the inspection target is irradiated;
an optical system configured to irradiate the inspection target with the light having the wavelength spectrum corresponding to the lighting condition at the angle corresponding to the lighting condition; and
a determination unit configured to determine whether a shape of the inspection target is good or defective based on imaging data of the inspection target imaged by the light emitted from the optical system.

2. The image inspection system according to claim 1, wherein
the inspection target includes an adhesive on a lead frame.

3. The image inspection system according to claim 2, wherein
the optical system is configured to function as an oblique lighting in a case where the lead frame is subjected to roughening plating.

4. The image inspection system according to claim 3, wherein
the lighting condition determination unit is configured to determine different lighting conditions for two inspection targets different from each other in at least one selected from a type of the lead frame, a type of the adhesive, and a method of the roughening plating.

5. The image inspection system according to claim 4, wherein
the optical system is configured to function as a coaxial lighting in a case where the lead frame is not subjected to roughening plating.

6. The image inspection system according to claim 2, wherein
the determination unit is configured to detect a shape of the adhesive based on a luminance difference in the imaging data.

7. The image inspection system according to claim 1, wherein
the light having the wavelength spectrum corresponding to the lighting condition is adjusted by a set including a white light source, a red light source, a green light source, and a blue light source.

8. The image inspection system according to claim 1, wherein
the lighting condition includes irradiating light of a second wavelength spectrum at a second angle while irradiating light of a first wavelength spectrum at a first angle.

9. An image inspection method comprising:
determining, based on an inspection target, a lighting condition including a wavelength spectrum and an irradiation angle of light with which the inspection target is irradiated;
irradiating the inspection target with the light having the wavelength spectrum corresponding to the lighting condition from an optical system at the angle corresponding to the lighting condition; and
determining whether a shape of the inspection target is good or defective based on imaging data of the inspection target imaged by the light emitted from the optical system.

10. The image inspection method according to claim 9, wherein
the inspection target includes an adhesive on a lead frame.

11. The image inspection method according to claim 10, further comprising:
causing the optical system to function as an oblique lighting in a case where the lead frame is subjected to roughening plating.

12. The image inspection method according to claim 11, further comprising:
determining different lighting conditions for two inspection targets different from each other in at least one selected from a type of the lead frame, a type of the adhesive, and a method of the roughening plating.

13. The image inspection method according to claim 12, further comprising:
causing the optical system to function as a coaxial lighting in a case where the lead frame is not subjected to roughening plating.

14. The image inspection method according to claim 10, further comprising:
detecting a shape of the adhesive based on a luminance difference in the imaging data.

15. The image inspection method according to claim 9, further comprising:
adjusting the light having the wavelength spectrum corresponding to the lighting condition by a set including a white light source, a red light source, a green light source, and a blue light source.

16. The image inspection method according to claim 9, wherein
the lighting condition includes irradiating light of a second wavelength spectrum at a second angle while irradiating light of a first wavelength spectrum at a first angle.
